(19) United States
(12) Patent Application Publication
(10) Pub. No.: US 2009/0057372 A1
(43) Pub. Date: Mar. 5, 2009

(54) CONDUCTIVE BALL MOUNTING APPARATUS

(75) Inventors: Kazuo NIIZUMA, Kanazawa-shi (JP); Naohiro HASHIBA, Kanazawa-shi (JP)

Correspondence Address: DRINKER BIDDLE & REATH (DC), 1500 K STREET, N.W., SUITE 1100, WASHINGTON, DC, 20005-1209, US

(73) Assignee: SHIBUYA KOGYO CO., LTD., Kanazawa-shi (JP)

(21) Appl. No.: 12/200,002

(22) Filed: Aug. 28, 2008

(30) Foreign Application Priority Data
Aug. 29, 2007 (JP) 2007-222586

(51) Int. Cl. B23Q 15/00

(52) U.S. Cl. 228/9

(57) ABSTRACT

A conductive ball mounting apparatus includes a stage including a placement surface, stage moving means that moves the stage between a supply position and a mounting position, mounting means that comprises an array mask and mounts the conductive ball to the object to be mounted via the array mask, elevating means that changes a distance between the array mask of the mounting means and the placement surface of the stage, and thickness measuring means provided at the supply position so as to measure a thickness of the object to be mounted placed on the placement surface. The thickness of the object to be mounted is measured at the supply position, and the conductive ball is mounted by controlling the elevating means to set a distance between an upper surface of the array mask and an upper surface of the object to be mounted at the mounting position to a predetermined value in accordance with the measured thickness.

This application claims priority from Japanese Patent Application No. 2007-222586 filed on Aug. 29, 2007, the entire subject matter of which is incorporated herein by reference.

### BACKGROUND OF THE INVENTION

1. Field of the Invention

The present invention relates to an improvement in a conductive ball mounting apparatus, and more particularly, to a conductive ball mounting apparatus capable of controlling a distance between an array mask and an object to be mounted, where the array mask is provided on the object to be mounted as a wafer on which flux is printed, and a ball cup storing a plurality of conductive balls moves along an upper surface of the array mask so that the conductive balls are dropped into through-holes of the array mask to be thereby mounted onto the object to be mounted.

2. Description of the Related Art

In the past, as disclosed in JP-A-2007-88344, a conductive ball mounting apparatus is known in which an array mask is provided on an object to be mounted as a wafer on which flux is printed, and a ball cup storing a plurality of solder balls moves along an upper surface of the array mask so that the conductive balls are dropped into through-holes of the array mask to be thereby mounted onto the wafer.

In such a conductive ball mounting apparatus, in order to prevent flux from being adhered to the array mask at the time of dropping the conductive ball as the solder ball by moving the ball cup, a gap between the array mask and the wafer is maintained to be larger than a thickness of the applied flux. In general, the gap between the array mask and the wafer during the mounting operation is set so that the array mask and the stage having the wafer placed thereon are away from each other by a predetermined distance in a manner that a thickness of the wafer is used as a reference thickness.

Incidentally, the thickness of the wafer is non-uniform, and the maximum non-uniform degree is 100 μm or so. In some cases, the non-uniform degree is a half or more of a diameter of the solder ball in use. For example, as shown in FIG. 5, when a thickness of a wafer 14 is thinner than a reference thickness, a solder ball 21B located above a dropped solder ball 21A may deeply enter a though-hole 18 or the solder ball 21A may be pressed by the solder ball 21B to easily enter between an array mask 19 and the wafer 14, thereby causing a problem of double balls.

On the contrary, as shown in FIG. 6, when the thickness of the wafer 14 is thicker than the reference thickness, an upper portion of the dropped solder ball 21A may protrude more than an upper surface of the array mask 19, thereby causing a problem that the solder ball 21A is cut or damaged by a ball cup 23 moving adjacent to the upper surface of the array mask 19.

### SUMMARY OF THE INVENTION

An object of the invention is to provide a conductive ball mounting apparatus capable of preventing double balls from occurring and preventing a solder ball from being cut or damaged by appropriately controlling a distance between an upper surface of an array mask and an upper surface of an object to be mounted.

In order to solve the above-described problems, according to a first aspect of the invention, there is provided a conductive ball mounting apparatus comprising: a stage comprising a placement surface, the placement surface adsorbing and supporting an object to be mounted; stage moving means that moves the stage between a supply position where the object to be mounted is supplied and a mounting position where a conductive ball is mounted on the object to be mounted; mounting means that comprises an array mask at the mounting position and mounts the conductive ball to the object to be mounted via the array mask; elevating means that is configured to change a distance between the array mask of the mounting means and the placement surface of the stage; and thickness measuring means that is provided at the supply position so as to measure a thickness of the object to be mounted placed on the placement surface, wherein the thickness of the object to be mounted is measured at the supply position, and wherein the conductive ball is mounted by controlling the elevating means to set a distance between an upper surface of the array mask and an upper surface of the object to be mounted at the mounting position to a predetermined value in accordance with the measured thickness of the object to be mounted.

According to a second aspect of the invention, the conductive ball mounting apparatus further comprises: warp correcting means that is configured to correct a warp of the object to be mounted placed on the stage at the supply position, wherein, at the supply position, the warp is corrected by the warp correcting means and the thickness of the object to be mounted is measured.

According to a third aspect of the invention, the object to be mounted comprises an electrode on which the conductive ball is placed, the warp correcting means comprises a pressing member for contacting and pressing a peripheral portion of the object to be mounted outside of a region where the electrode is formed, and the thickness of the object to be mounted is measured by measuring a height of an upper surface of the pressing member.

According to a fourth aspect of the invention, the conductive ball mounting apparatus further comprises: printing means that comprises a printing mask at a position adjacent to the mounting position and prints flux on the object to be mounted via the printing mask, wherein the elevating means controls a distance between an upper surface of the printing mask and the upper surface of the object to be mounted to a predetermined value in accordance with the thickness of the object to be mounted measured at the supply position.

According to a fifth aspect of the invention, there is provided a method for mounting a conductive ball using a conductive ball mounting apparatus, wherein the conductive ball mounting apparatus comprises: a stage comprising a placement surface; stage moving means; mounting means comprising an array mask; elevating means; and thickness measuring means, and wherein the method comprises: placing the object to be mounted on the placement surface of the stage at a supply position; measuring a thickness of the object to be mounted by the thickness measuring means; moving the stage to a mounting position by the stage moving means; setting a distance between an upper surface of the array mask and an upper surface of the object to be mounted at the mounting position to a predetermined value by the elevating means in accordance with the thickness of the object to be mounted; and mounting a conductive ball on the object to be mounted via the array mask by the mounting means.

According to a sixth aspect of the invention, the conductive ball mounting apparatus further comprises warp correcting means, and the method further comprises correcting a warp of the object to be mounted by the warp correcting means between the placing the object to be mounted on the placement surface of the stage at the supply position and the measuring the thickness of the object to be mounted.

According to the aspects of the invention, the thickness measuring means for measuring the thickness of the object to be mounted placed on the placement surface is provided at the supply position of the object to be mounted. In the aspects of the invention, the thickness of the object to be mounted at the supply position is measured, and the conductive ball is mounted by controlling the elevating means so as to have a predetermined distance between the upper surface of the array mask and the upper surface of the object to be mounted at the mounting position in accordance with the measured thickness. Accordingly, it is possible to prevent a problem that the solder ball 21B located above the dropped solder ball 21A enters deeply the through-hole 18 or the solder ball 21A is pressed by the solder ball 21B to easily enter between the array mask 19 and the wafer 14. Additionally, it is possible to prevent a problem that the upper portion of the dropped solder ball 21A protrudes more than the upper surface of the array mask 19, and thus the solder ball 21A is cut or damaged by the ball cup 23 moving adjacent to the upper surface of the array mask 19.

According to the second aspect of the invention, there is provided the conductive ball mounting apparatus including the warp correcting means which is provided at the supply position of the object to be mounted so as to correct the warp of the object to be mounted placed on the stage, at the supply position, the warp is corrected and the thickness of the object to be mounted is measured. Accordingly, even in the warped object to be mounted, it is possible to appropriately maintain a distance between the upper surface of the array mask and the upper surface of the object to be mounted.

According to the third aspect of the invention, there is provided the conductive ball mounting apparatus in which the warp correcting means includes the pressing member for contacting and pressing the peripheral portion of the object to be mounted, the electrode being not formed at the peripheral portion, and the thickness of the object to be mounted is measured by measuring the height of the upper surface of the pressing member. Accordingly, it is possible to measure the thickness of the object to be mounted with high precision regardless of the position of the electrode formed on the object to be mounted.

According to the fourth aspect of the invention, there is provided the flux printing means provided at a position adjacent to the mounting position and the distance is controlled by using the elevating means in accordance with the thickness of the object to be mounted. Accordingly, it is possible to perform the flux printing operation with high precision, thereby providing the high-precision conductive ball mounting apparatus.

### BRIEF DESCRIPTION OF THE DRAWINGS

FIG. 1 is a schematic top view showing the entirety of a solder ball mounting apparatus according to an embodiment;

FIG. 2 is a side view showing a ball mounting part;

FIG. 3 is a side view showing a wafer supply part;

FIG. 4 is a top view showing the wafer supply part;

FIG. 5 is an explanatory view showing a state of a solder ball in a wafer thinner than a reference thickness; and

FIG. 6 is an explanatory view showing a state of the solder ball in a wafer thicker than the reference thickness.

### DETAILED DESCRIPTION OF THE PREFERRED EMBODIMENTS

Hereinafter, an exemplary embodiment of the invention will be described with reference to the accompanying drawings. In this invention, a semiconductor wafer (hereinafter, simply referred to as a wafer), an electronic circuit substrate or a ceramic substrate is exemplified as a target for mounting conductive balls, but a wafer 14 is used in this embodiment. Additionally, flux, solder paste or a conductive adhesive is used as an adhesive material, but flux 38 is used in this embodiment. Solder balls 21 are used as conductive balls.

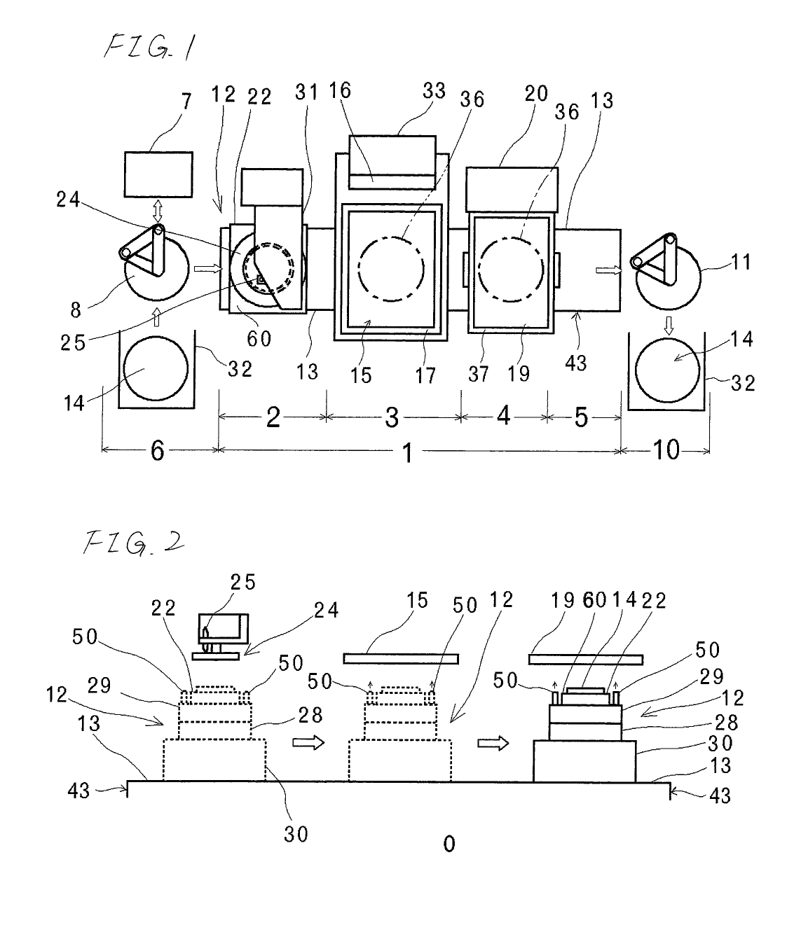

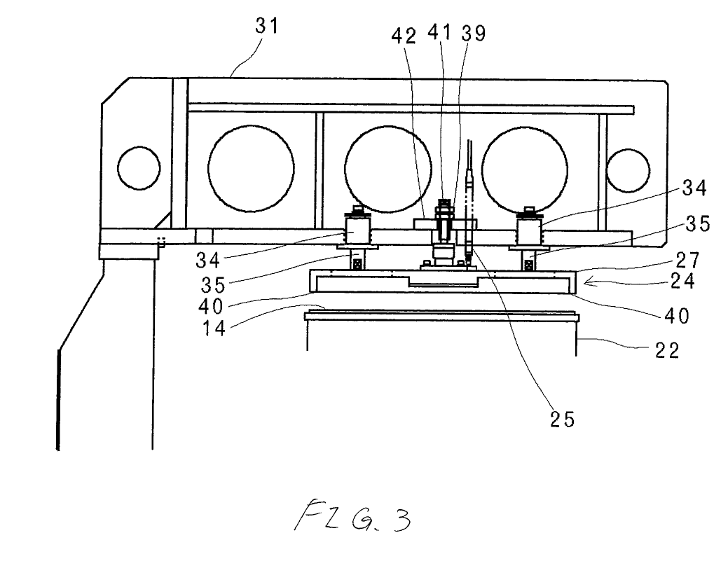

FIG. 1 is a schematic top view showing the entirety of a solder ball mounting apparatus 1. The solder ball mounting apparatus 1 includes a carry-in wafer supply part 2, a flux printing part 3, a ball mounting part 4, and a carry-out wafer transfer part 5 in an order from the left side of FIG. 1. A wafer accommodation part 6, a primary alignment part 7, and a carry-in robot 8 exist at the pre-step of the solder ball mounting apparatus 1, and a wafer housing part 10 and a carry-out robot 11 exist at the post-step of the solder ball mounting apparatus 1.

The primary alignment part 7 for the pre-step is configured to turn the wafer 14 in a horizontal plane, and turns the wafer 14 so as to detect the position of an orientation flat or notch of the wafer 14, to correct the position of the wafer 14 approximately, and to direct the wafer 14, which will be mounted on the wafer supply part 2, in a predetermined direction.

The solder ball mounting apparatus 1 is provided with a wafer transfer stage 12 and a transfer passage 13 for transferring the wafer 14 from the wafer supply part 2 to the flux printing part 3, the ball mounting part 4, and the wafer transfer part 5. The solder ball mounting apparatus 1 is provided with a movement device 43, which includes the transfer passage 13, as a moving means for moving the transfer stage 12 in an X-axis direction (horizontal direction in the drawing).

An adsorption stage 22 for adsorbing and supporting the wafer 14 exists in the wafer transfer stage 12. The wafer transfer stage 12 having the adsorption stage 22 is capable of moving in an X-axis direction by using the transfer passage 13, and is capable of moving among the wafer supply part 2 corresponding to a supply position of the wafer 14, the flux printing part 3, the ball mounting part 4 corresponding to a mounting position for mounting the solder balls 21, and the wafer transfer part 5.

Additionally, the wafer transfer stage 12 includes a Y-axis drive mechanism 28 as moving means in a direction (Y-axis direction) perpendicular to a transfer direction of the wafer 14, a θ-axis drive mechanism 29 as turning means, and a Z-axis drive mechanism 30 as elevating means. The Z-axis drive mechanism 30 is used for an elevation to measure a thickness of the wafer 14 at the wafer supply part 2, for a distance control between a printing mask 15 and the wafer 14 at the flux printing part 3, and for a distance control between a ball array mask 19 and the wafer 14 at the time of mounting the solder balls 21 to the wafer 14 at the ball mounting part 4. Additionally, two units of mask recognizing cameras 50 are uprightly mounted in the vicinity of the adsorption stage 22 of the wafer transfer stage 12 so as to recognize an alignment mark formed on the lower surface of the printing mask 15 or the ball array mask 19.

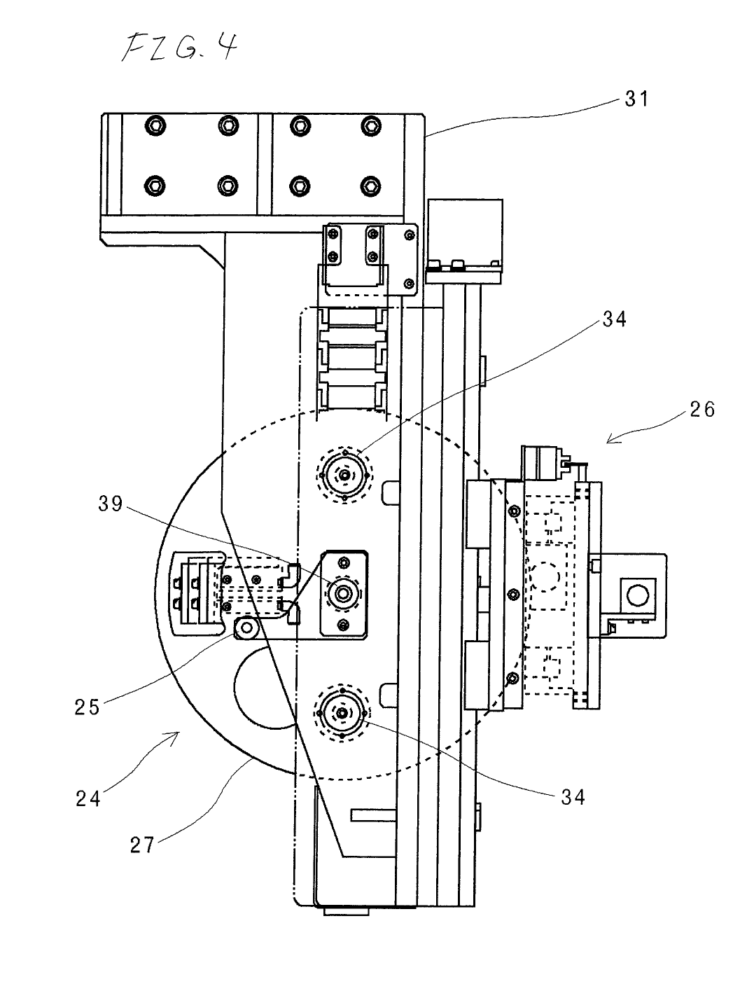

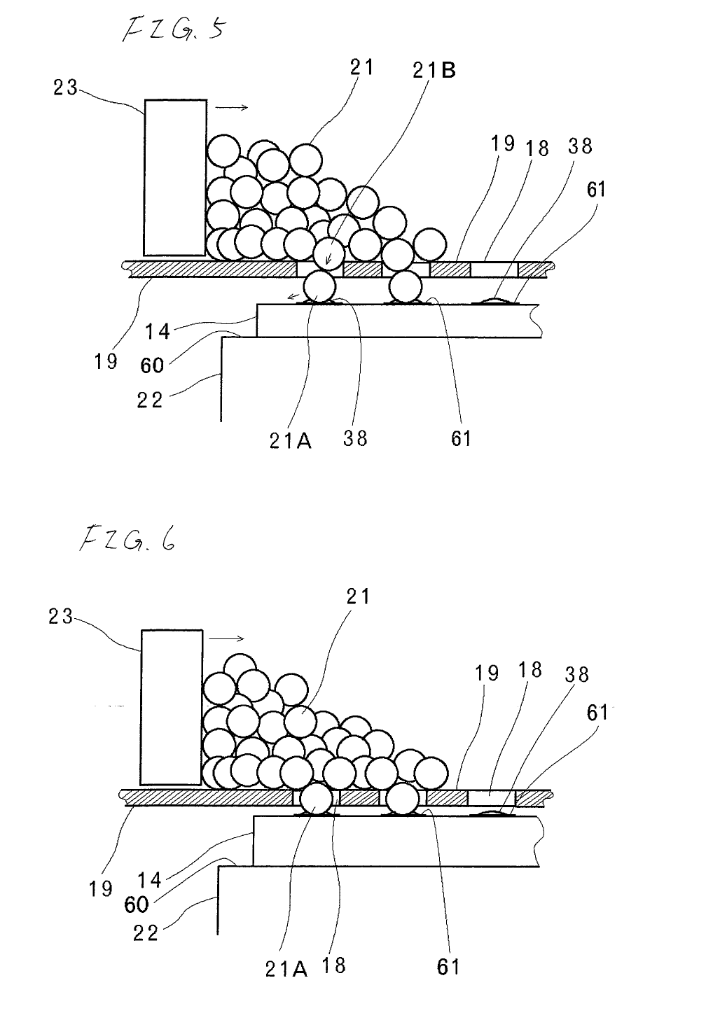

As shown in FIG. 4, the wafer supply part 2 corresponding to the wafer supply position according to the invention is provided with a warp correcting device 24, a thickness measuring device 25, and an alignment mark recognizing device 26. Here, the alignment mark recognizing device 26 recognizes the alignment marks at two positions of the wafer 14 placed on a placement surface 60 of the adsorption stage 22 so as to position the wafer 14 to the printing mask 15 or the ball array mask 19 at the flux printing part 3 or the ball mounting part 4.

Since it is not possible to correct a warp of the wafer 14 just by using the placement surface 60 at the upper surface of the adsorption stage 22 of the wafer transfer stage 12, the wafer supply part 2 is provided with a warp correcting device 24. Although electrodes 61 of the wafer 14 are formed in accordance with an arrangement pattern and are formed in a protruding manner or in a recessed manner in accordance with the types, the electrodes 61 are not formed in the peripheral portion. Accordingly, the warp correcting device 24 is configured as a circular pressing member 27 having a ring-shaped contact surface 40 coming into contact with the peripheral portion of the wafer 14 where the electrodes 61 are not formed, and is provided while being suspended on a frame 31 provided in a protruding manner above the transfer passage 13 of the wafer supply part 2.

Specifically, the frame 31 is provided with a horizontal support surface 42 and a through-hole formed through the support surface 42, and a screw shaft 41 is formed at the center of the upper surface of a circular pressing member 27. The screw shaft 41 is fitted into the through-hole formed through the support surface 42 with a tolerance, and a nut 39 is screw-mounted to a protruding portion above the support surface 42 so that the lower surface of the nut 39 comes into contact with the support surface 42 of the frame 31. Accordingly, the circular pressing member 27 is capable of moving upward, and the lower limit position of the circular pressing member 27 is set by adjusting the position of the nut 39.

When the adsorption stage 22 moves up in a state where the wafer 14 is placed on the adsorption stage 22, since the circular pressing member 27 located at the lower limit position is pressed upward, the own weight of the circular pressing member 27 acts as a downward pressing force, thereby correcting the warp of the wafer 14. The upper surface of the circular pressing member 27 is provided with two guide pins 35 with the screw shaft 41 interposed therebetween, and the frame 31 is provided with a cylindrical guide 34, thereby guiding the vertical movement of the guide pin 35 by using the guide 34. Additionally, when the adsorption is once carried out on the upper surface of the adsorption stage 22 of the wafer transfer stage 12 after the warp is corrected by the warp correcting device 24, since the adsorption is maintained up to the ball mounting position, the warp cannot be restored.

Although the thickness measuring device 25 may be configured as a contact sensor or a non-contact sensor, a contact sensor capable of performing a high-precision measurement is used in this embodiment. The thickness measuring device 25 is attached to the frame 31, and the thickness of the wafer 14 is obtained by measuring a height of the upper surface of the circular pressing member 27.

The thickness measuring device 25 sets a reference position in such a manner that the placement surface 60 of the adsorption stage 22 without the wafer 14 comes into contact with the circular pressing member 27 and moves up by a predetermined position, and the thickness measuring device 25 outputs zero (0) at the height of the upper surface of the circular pressing member 27 at this time. Then, when the adsorption stage 22 having the wafer 14 placed thereon moves up to the reference position, the thickness measuring device 25 measures the height of the upper surface of the circular pressing member 27 pressed upward by the wafer 14, and obtains a value of the thickness from a difference between the reference position and the measured position. Additionally, the thickness of the wafer 14 within one lot is considerably non-uniform, and the maximum non-uniform degree of the wafer 14 is 100 μm or so. On the contrary, there are few thickness variation within the wafer 14.

The flux printing part 3 is provided with a flux supply device 16 and a printing mask 15 for printing flux as adhesive material on the wafer 14. The printing mask 15 is provided with through-holes arranged in accordance with the arrangement pattern of the electrodes 61 of the wafer 14. An alignment mark (not shown) is marked at two positions of the lower surface of the printing mask 15 within a through-hole forming area 36 so as to be adhered to a molding frame 17 and held by a fixing portion such as a frame.

The flux supply device 16 prints flux on an area within the through-hole of the printing mask 15 by moving a stage (not shown) along the upper surface of the printing mask 15 so as to be supplied to the electrodes 61 of the wafer 14. Additionally, Reference numeral 33 in the drawing denotes a cleaning unit for removing the flux attached to the printing mask 15. Even in the flux printing part 3, a distance between the printing mask 15 and the wafer 14 is controlled by the Z-axis drive mechanism 30 in accordance with the thickness of the wafer 14 measured at the wafer supply part 2.

The ball mounting part 4 is provided with a solder ball supply device 20 and the ball array mask 19 having through-holes 18 arranged in accordance with the pattern of the electrodes 61 on the wafer 14.

A thickness of the ball array mask 19 is about a half of a diameter of each supplied solder ball 21, and a diameter of each through-hole 18 is slightly larger than that of the solder ball 21. Additionally, in the same manner as the printing mask 15, an alignment mark (not shown) is marked at two positions of the lower surface of the ball array mask 19 within the through-hole forming area 36 so as to be adhered to a molding frame 37 and held by a fixing portion.

The solder ball supply device 20 includes a ball hopper for storing a plurality of solder balls 21, a ball cup 23 for dropping the solder ball 21 to the ball array mask 19, and a movement unit for moving the ball cup 23 along X-axis and Y-axis guides and in a Z-axis direction. By moving the ball cup 23 along the upper surface of the ball array mask 19, the solder balls 21 are mounted to the wafer 14 via the through-holes 18. Additionally, the ball hopper is exchanged in accordance with the size and the material of the solder ball 21.

Hereinafter, an operation of the solder ball mounting apparatus 1 according to the embodiment will be described with reference to the accompanying drawings. First, the wafer 14 to be mounted with the solder balls 21 is accommodated in a cassette 32 of the wafer accommodation part 6. Subsequently, one sheet of wafer 14 is extracted from the cassette 32 of the wafer accommodation part 6 by the carry-in robot 8, and is carried into the primary alignment part 7. The primary alignment part 7 turns the wafer 14 so as to detect the position of an orientation flat or notch, to correct the position of the wafer 14 approximately, and to direct the orientation flat or the notch in a predetermined direction. Subsequently, the wafer 14 is placed from the primary alignment part 7 onto the wafer transfer stage 12 staying at the wafer supply part 2 by the carry-in robot 8. Herein, before mounting the wafer, the position of the placement surface 60 of the adsorption stage 22 moved up to the reference position is measured by the thickness measuring device 25, and the measured value is set to a reference value (0).

When the wafer 14 is adsorbed by the adsorption stage 22 of the transfer stage 12, the adsorption stage 22 moves up by using the Z-axis drive mechanism 30, and the peripheral portion of the wafer 14 is brought into contact with the ring-shaped contact surface 40 of the circular pressing member 27 of the warp correcting device 24. Accordingly, the warp of the wafer 14 is corrected, and a thickness of the wafer 14 is measured by the thickness measuring device 25. Subsequently, a coordinate position of the alignment mark of the wafer 14 is recognized by the alignment mark recognizing device 26.

After recognizing the coordinate position of the alignment mark at the supply position, the wafer transfer stage 12 having the wafer 14 placed thereon moves to the flux printing part 3 along the transfer passage 13 and stops at a predetermined position. Here, the coordinate positions of the alignment marks of the wafer 14 and the printing mask 15 are recognized by the mask recognizing cameras 50, and the positioning operation is carried out by moving the wafer transfer stage 12 in X-axis, Y-axis, and θ-axis directions by using the X-axis drive mechanism, the Y-axis drive mechanism 28, and the θ-axis drive mechanism 29 in the transfer passage 13 so that the alignment marks of the wafer 14 are identical with the alignment marks of the printing mask 15.

After ending the positioning operation, the wafer transfer stage 12 moves up by using the Z-axis drive mechanism 30 in accordance with the thickness of the wafer 14 measured at the wafer supply part 2, and stops at a predetermined height position with respect to the printing mask 15 having the flux 38 prepared therein. In this state, the flux is supplied to one end portion of the printing mask 15 in a Y-axis direction, and the flux is printed on the electrodes 61 on the wafer 14 via the through-holes of the printing mask 15 by moving a squeegee to the other end portion.

After printing the flux, the wafer transfer stage 12 moves down by using the Z-axis drive mechanism 30, and moves to the ball mounting part 4 by using the transfer passage 13 to stop at a predetermined position. In the same manner, the alignment marks of the ball array mask 19 are recognized by the mask recognizing cameras 50, and the positioning operation is carried out by moving the wafer transfer stage 12 in X-axis, Y-axis, and θ-axis directions by using the X-axis drive mechanism, the Y-axis drive mechanism 28, and the θ-axis drive mechanism 29 in the transfer passage 13 so that the alignment marks of the wafer 14 are identical with the alignment marks of the ball array mask 19. Subsequently, the wafer transfer stage 12 moves up the adsorption stage 22 by using the Z-axis drive mechanism 30 in accordance with the thickness of the wafer 14 measured at the wafer supply part 2 so as to change a distance between the ball array mask 19 and the placement surface 60, and stops at a position having a predetermined distance between the upper surface of the ball array mask 19 and the upper surface of the wafer 14 on the adsorption stage 22.

The solder balls 21 are dropped into the through-holes 18 of the ball array mask 19 by moving the ball cup 23 along the ball array mask 19 so that the solder balls 5 21 are mounted onto the wafer 14. In some cases, the positions of the solder balls 21 within the through-holes 18 are corrected by slightly moving the ball array mask 19 with respect to the wafer transfer stage 12 in a horizontal direction (X-axis and Y-axis directions) after dropping the solder balls.

After mounting the solder balls, the wafer transfer stage 12 moves down by using the Z-axis drive mechanism 30, and moves and stops at the carry-out wafer transfer part 5. In the wafer housing part 10, the wafer 14 is placed from the wafer transfer stage 12 to the cassette 32 of the wafer housing part 10 by the carry-out robot 11. When the carry-out robot 11 extracts the wafer 14 from the wafer transfer stage 12, the wafer transfer stage 12 moves back to an original position, that is, the wafer supply part 2, thereby ending one step. This apparatus repeats the above-described operations.

What is claimed is:

1. A conductive ball mounting apparatus comprising:
a stage comprising a placement surface, the placement surface adsorbing and supporting an object to be mounted;
stage moving means that moves the stage between a supply position where the object to be mounted is supplied and a mounting position where a conductive ball is mounted on the object to be mounted;
mounting means that comprises an array mask at the mounting position and mounts the conductive ball to the object to be mounted via the array mask;
elevating means that is configured to change a distance between the array mask of the mounting means and the placement surface of the stage; and
thickness measuring means that is provided at the supply position so as to measure a thickness of the object to be mounted placed on the placement surface,
wherein the thickness of the object to be mounted is measured at the supply position, and
wherein the conductive ball is mounted by controlling the elevating means to set a distance between an upper surface of the array mask and an upper surface of the object to be mounted at the mounting position to a predetermined value in accordance with the measured thickness of the object to be mounted.

2. The conductive ball mounting apparatus according to claim 1, further comprising:
warp correcting means that is configured to correct a warp of the object to be mounted placed on the stage at the supply position,
wherein, at the supply position, the warp is corrected by the warp correcting means and the thickness of the object to be mounted is measured.

3. The conductive ball mounting apparatus according to claim 2,
wherein the object to be mounted comprises an electrode on which the conductive ball is placed,
wherein the warp correcting means comprises a pressing member for contacting and pressing a peripheral portion of the object to be mounted outside of a region where the electrode is formed, and
wherein the thickness of the object to be mounted is measured by measuring a height of an upper surface of the pressing member.

4. The conductive ball mounting apparatus according to claim 1, further comprising:
printing means that comprises a printing mask at a position adjacent to the mounting position and prints flux on the object to be mounted via the printing mask,
wherein the elevating means controls a distance between an upper surface of the printing mask and the upper surface of the object to be mounted to a predetermined value in accordance with the thickness of the object to be mounted measured at the supply position.

5. A method for mounting a conductive ball using a conductive ball mounting apparatus,
wherein the conductive ball mounting apparatus comprises:
a stage comprising a placement surface;
stage moving means;
mounting means comprising an array mask;
elevating means; and
thickness measuring means, and
wherein the method comprises:
placing the object to be mounted on the placement surface of the stage at a supply position;
measuring a thickness of the object to be mounted by the thickness measuring means;
moving the stage to a mounting position by the stage moving means;
setting a distance between an upper surface of the array mask and an upper surface of the object to be mounted at the mounting position to a predetermined value by the elevating means in accordance with the thickness of the object to be mounted; and
mounting a conductive ball on the object to be mounted via the array mask by the mounting means.

6. The method for mounting a conductive ball according to claim 5,
wherein the conductive ball mounting apparatus further comprises warp correcting means, and
wherein the method further comprises correcting a warp of the object to be mounted by the warp correcting means between the placing the object to be mounted on the placement surface of the stage at the supply position and the measuring the thickness of the object to be mounted.
